(19) United States
(12) Patent Application Publication
(10) Pub. No.: US 2018/0013528 A1
(43) Pub. Date: Jan. 11, 2018

(54) SEARCH SPACE SHARING METHOD IN ENHANCED CARRIER AGGREGATION, AND BASE STATION AND USER EQUIPMENT

(71) Applicants: Sharp Kabushiki Kaisha, Sakai City, Osaka (JP); SHANGHAI JIAO TONG UNIVERSITY, Shanghai (CN)

(72) Inventors: SHOHEI YAMADA, Sakai City (JP); QI JIANG, Shanghai (CN); ZHE LUO, Shanghai (CN)

(21) Appl. No.: 15/544,691

(22) PCT Filed: Jan. 18, 2016
(86) PCT No.: PCT/CN2016/071172

§ 371 Date: Jul. 19, 2017

(30) Foreign Application Priority Data
Jan. 20, 2015 (CN) 201510028325.5

(51) Int. Cl. H04L 5/00; H04W 72/04; H04W 52/14

(52) U.S. Cl. CPC H04L 5/0037; H04L 5/0053; H04W 52/146; H04W 72/042; H04L 5/001; H04L 5/0094

(57) ABSTRACT

The present invention provides a communication method in a base station and a corresponding base station. The method includes: a base station communicating with a user equipment in multiple serving cells, and configuring a search space sharing indicator for the multiple cells. The method further includes: the base station sending a physical downlink control channel (PDCCH)/enhanced physical downlink control channel (EPDCCH) based on a specific search space of the user equipment to the user equipment, where in the case of configuring the user equipment with a carrier indicator field (CIF) or an extended carrier indicator field (ECIF) and configuring the user equipment with a shared search space, a candidate location of a control channel element (CCE) of the PDCCH/enhanced control channel element (ECCE) of the EPDCCH detected by each serving cell configured to share the search space in the whole search space is determined by a cell identification of another configured serving cell sharing the search space therewith. Correspondingly, the present invention further provides a communication method in a user equipment and a corresponding user equipment.

### TECHNICAL FIELD

The present invention relates to the technical field of wireless communications. More particularly, the present invention relates to a resource allocation method for communications between devices, along with a base station and a user equipment.

### BACKGROUND

Modern wireless mobile communication systems present two significant characteristics: one is broadband and high speed, for example, a bandwidth of a fourth-generation wireless mobile communication system can reach 100 MHz, and a downlink speed reaches up to 1 Gbps; and the other one is the mobile Internet, which promotes emerging businesses such as mobile Internet access, mobile phone video on demand, on-line navigation, and the like. The two characteristics put forward relatively high requirements on wireless mobile communication technology, mainly including: ultrahigh-speed wireless transmission, inter-region interference suppression, reliable signal transmission when in motion, distributive-type/intensive-type signal processing, and the like. In future enhanced fourth-generation (4G) and fifth-generation (5G) wireless mobile communication systems, in order to meet the above-mentioned development requirements, various corresponding key techniques are beginning to be proposed and demonstrated, which is worthy of gaining more and more attention within the research personnel in the art.

In October, 2007, the International Telecommunications Union (ITU) ratified a Worldwide Interoperability for Microwave Access (WiMax) to become a fourth 3G system standard. The event happening during the last stage of a 3G era is, in reality, a preview of a 4G standard battle. In fact, since 2005, in order to meet the challenge of a wireless Internet Protocol (IP) technical flow representative of a wireless local area network and the WiMax, a 3GPP organization has initiated a brand-new system upgrade, namely standardization of a Long Term Evolution (LTE) system. This is a Quasi-4G system based on Orthogonal Frequency Division Multiplexing (OFDM). The first version was pushed out at the beginning of 2009, and began to be commercially available in succession all over the world in 2010. Meanwhile, the 3GPP organization had initiated standardization of the 4G wireless mobile communication system since the first half year of 2008. The system is called the Long Term Evolution Advanced (LTE) system. A key standardization document of a physical layer process of the system had been completed at the beginning of 2011. In November, 2011, the ITU announced, in Chongqing, China, that the LTE-A system and the WiMax system are two official standards of the 4G system. At present, a commercial process of the LTE-A system is being developed gradually around the world.

According to challenges in the coming ten years, the following development demands are substantial for an enhanced 4G wireless mobile communication system:
a higher wireless broadband speed is required, and optimization of local cell hot spot regions is emphasized;
the user experience is further improved, particularly it is necessary to optimize communication services of cell boundary regions;
in view of it being impossible to expand clear bandsspectra 1000 times, it is necessary to continue researching a new technology capable of improving spectrumband utilization efficiency;
high-frequency bands spectra (5 GHz or greater) will certainly come into use to obtain a larger communication bandwidth;
existing networks (2G/3G/4G, WLAN, WiMax, and the like.) cooperate to share data traffic;
different services, applications and service are specifically optimized;
a system capability of supporting large-scale machine communications is supported;
network planning and distribution are flexible, smart and inexpensive;
a solution is designed to save the power consumption of a network and the battery consumption of a user equipment.
the enhanced carrier aggregation technology aims at supporting maximum aggregation of up to 32 component carriers.

At present, in the traditional 3GPP LTE system, whether the uplink transmission or downlink transmission can support, at most, the aggregation of five component carriers, and if each component carrier is up to 20 MHz, the user equipment can simultaneously support, at most, the uplink and downlink transmission of 100 MHz. With the growing demand of data traffic, it has been difficult to meet the future need of 100 MHz transmission bandwidth. A new research subject, i.e. research of LTE carrier aggregation enhancement beyond 5 carriers (RP-142286) was discussed at the 66^{th} 3GPP RAN Conference, which mainly aimed at researching aggregation technology supporting up to 32 component carriers (CC) during uplink and downlink so as to increase the transmission speed.

Based on this object, the system design will have a critical problem, i.e. the complexity of the user equipment. The current search space and blind detection times of the PDCCH/EPDCCH of the user equipment is a specific design mode of the cell. That is, the search space corresponding to each serving cell is fixed, while the blind detection times of each aggregation level of the PDCCH/EPDCCH is also fixed. One UE can, at most, support the simultaneous monitoring of the search space on five CCs, and performs blind detection of the PDCCH/EPDCCH on the five CCs. If the simultaneous transmission of up to 32 CCs is during downlink, the search space monitored by the UE needs to be enlarged by greater than 6 times (32/5) according to the existing protocol, and blind detection times will also be increased by corresponding times. It is apparent that the implementation complexity of the UE brings about great challenge.

For this problem, the present method gives a corresponding solution.

### SUMMARY

The technical problem to be overcome by the present invention is that each serving cell will have an independent search space if the original design mode of a search space is continued to be used. To support up to 32 downlink serving cells to simultaneously serve a user, a large monitoring space will be needed, and more time-frequency resources will be occupied.

In order to solve the above-mentioned problems, according to a first aspect of the present invention, provided is a communication method in a base station. The method includes: the base station communicating with a user equipment in multiple serving cells, and configuring a search space sharing indicator for the multiple cells. The method further includes: the base station sending a physical downlink control channel (PDCCH)/enhanced physical downlink control channel (EPDCCH) based on a specific search space of the user equipment to the user equipment, where in the case of configuring the user equipment with a carrier indicator field (CIF) or an extended carrier indicator field (ECIF) and configuring the user equipment with a shared search space, a candidate location of a control channel element (CCE) of the PDCCH/enhanced control channel element (ECCE) of the EPDCCH detected by each serving cell configured to share the search space in the whole search space is determined by a cell identification of another configured serving cell sharing the search space therewith.

According to a second aspect of the present invention, provided is a communication method in a user equipment. The method includes: the user equipment communicating with a base station in multiple serving cells, and receiving a search space sharing indicator configured by the base station for the multiple cells. The method further includes: the user equipment receiving a PDCCH/EPDCCH based on a user equipment specific search space, where in the case of configuring the user equipment with a carrier indicator field (CIF) or an extended carrier indicator field (ECIF) and configuring the user equipment with a shared search space, a candidate location of a control channel element (CCE) of the PDCCH/enhanced control channel element (ECCE) of the EPDCCH detected by each serving cell configured to share the search space in the whole search space is determined by a cell identification of another configured serving cell sharing the search space therewith.

According to a third aspect of the present invention, provided is a base station, which includes a multi-serving-cell communication unit and a PDCCH/EPDCCH sending unit. The multi-serving-cell communication unit is configured to communicate with a user equipment in multiple serving cells, and configure a search space sharing indicator for the multiple cells. The PDCCH/EPDCCH sending unit is configured to send the PDCCH/EPDCCH based on the specific search space of the user equipment to the user equipment, where in the case of configuring the user equipment with a carrier indicator field (CIF) or an extended carrier indicator field (ECIF) and configuring the user equipment with a shared search space, a candidate location of a control channel element (CCE) of the PDCCH/enhanced control channel element (ECCE) of the EPDCCH detected by each serving cell configured to share the search space in the whole search space is determined by a cell identification of another configured serving cell sharing the search space therewith.

According to a fourth aspect of the present invention, provided is a user equipment, which includes a multi-serving-cell communication unit and a PDCCH/EPDCCH receiving unit. The multi-serving-cell communication unit is configured to communicate with a base station in multiple serving cells, and receive a search space sharing indicator configured by the base station for the multiple cells. The PDCCH/EPDCCH receiving unit is configured to receive a PDCCH/EPDCCH based on a specific search space of the user equipment, wherein the case where the user equipment is configured with a carrier indicator field (CIF) or an extended carrier indicator field (ECIF) and configured with a shared search space, a candidate location of a control channel element (CCE) of the PDCCH/enhanced control channel element (ECCE) of the EPDCCH that needs to be detected by each serving cell configured as the shared search space in the whole search space is determined by a cell identification of another configured serving cell sharing the search space therewith.

Optionally, the number of candidate locations corresponding to the PDCCH/EPDCCH at each aggregation level in the search space corresponding to the serving cell configured to share the search space is configured by the base station.

Through the search space sharing method of the present invention, some or all cells among the 32 downlink serving cells can be configured in the same search space so as to reduce the size of the search space to be detected, and reduce the number of the actually-occupied time-frequency resources. Further, the times of blind detection on the PDCCH/EPDCCH by the UE can be further reduced by configuring the number of candidate location of each serving cell at each aggregation level.

### BRIEF DESCRIPTION OF THE DRAWINGS

The above-mentioned and other features of the present invention will become more apparent through the following detail description in combination with the drawings, where:

FIG. 1 is a flowchart illustrating a method at a base station side and a user equipment side according to an embodiment of the present invention;

FIG. 2 is a structural block diagram illustrating a base station according to an embodiment of the present invention; and

FIG. 3 is a structural block diagram illustrating a user equipment according to an embodiment of the present invention.

### DETAILED DESCRIPTION

The present invention provides a method for sending a physical downlink control channel (PDCCH)/enhanced physical downlink control channel (EPDCCH) based on a specific search space of a user equipment when a base station communicates with the user equipment in multiple serving cells. Correspondingly, the present invention further provides a method for receiving and decoding a PDCCH/EPDCCH of a user equipment corresponding to the sending method.

It shall be noted that the present invention is not limited to the embodiments described below. Furthermore, for the sake of simplicity and convenience, the detail description of the known technology that is not directly correlated to the present invention is omitted, so as to prevent misunderstanding of the present invention.

Embodiments according to the present invention are specifically described below by using an LTE mobile communication system and subsequent evolved versions thereof as an example application environment. However, it should be pointed out that the present invention is not limited to the following embodiments, but can be applied to other wireless communication systems, for example, a future 50 cellular communication system.

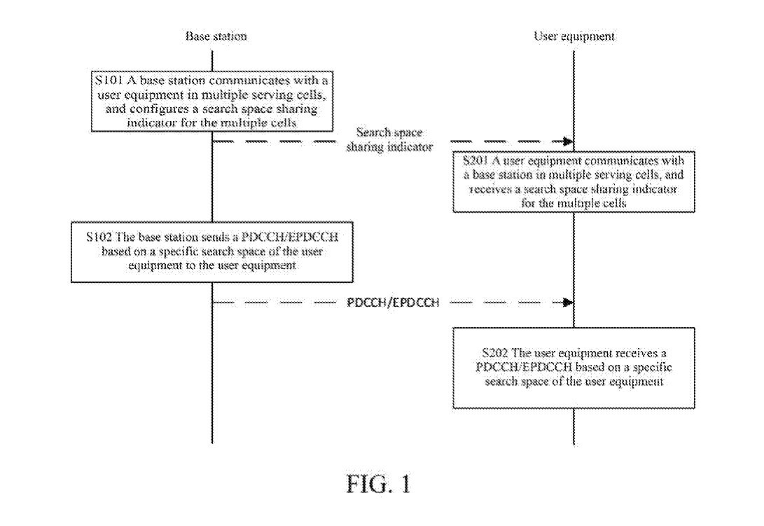

FIG. 1 is a flowchart illustrating a communication method at a base station side and a user equipment side according to embodiments of the present invention. As illustrated in FIG. 1, the method at the base station side includes steps S101 and S102. The method at the user equipment side includes steps S201 and S202.

In step S101, the base station communicates with the user equipment in multiple serving cells, and configures a search space sharing indicator for the multiple cells.

As an example, the search space sharing indicator is an SCellIndex information element (IE) in TS 36.331, which indicates that a serving cell sharing the search space with said serving cell is the indicated serving cell corresponding to SCellIndex.

As an example, the search space sharing indicator is physCellId in the TS 36.331, which indicates that a physical cell identification of a serving cell sharing the search space with said serving cell is the indicated physCellId.

As another example, the search space sharing indicator is a group of SCellIndex information elements (IE) in the TS 36.331, which indicates that a serving cell sharing the search space with said serving cell is a group of serving cells corresponding to the indicated SCellIndex.

As another example, the search space sharing indicator is a group of physCellId in the TS 36.331, which indicates that the physical cell identification of a group of serving cells sharing the search space with said serving cell is the indicated physCellId.

Correspondingly, in step S201, the user equipment communicates with the base station in multiple serving cells, and receives a search space sharing indicator configured by the base station for the multiple cells.

In step S102, the base station sends the PDCCH/EPDCCH based on the specific search space of the user equipment to the user equipment, where in the case of configuring the user equipment with a carrier indicator field (CIF) or an extended carrier indicator field (ECIF) and configuring the user equipment with a shared search space, a candidate location m of a control channel element (CCE) of the PDCCH/enhanced control channel element (ECCE) of the EPDCCH detected by each serving cell configured to share the search space in the whole search space is determined by a cell identification of another configured serving cell sharing the search space therewith.

As an example, if Sₖ^{(L)} is used to indicate a candidate search location of a corresponding PDCCH at an aggregation level Lε{1, 2, 4, 8}, and if the UE for detecting the PDCCH is configured with the carrier indicator field (CIF) or the extended carrier indicator field (ECIF) and the serving cell is configured with the search space sharing indicator c, m′=m+M^{(L)}·c in the following formula for calculating the Sₖ^{(L)}, where c is the SCellIndex of the serving cell sharing the search space with said serving cell.

L{(Yₖ+m′)mod └N_{CCE,k}/L┘}+i, i.

k is a sub-frame number, Yₖ is a constant difference related to k and RNTI allocated by the UE, N_{CCE,k} is the number of all CCEs on a k^{th} sub-frame, and i is 0 to (L−1).

As another example, if ESₖ^{(L)} is used to indicate a candidate search location of a corresponding PDCCH at an aggregation level L ε{1, 2, 4, 8, 16, 32}, and if the UE for detecting the PDCCH is configured with the carrier indicator field (CIF) or the extended carrier indicator field (ECIF) and the serving cell is configured with the search space sharing indicator c, b is equal to c in the following formula for calculating the ESₖ^{(L)}, where c is the SCellIndex of the serving cell sharing the search space with said serving cell.

$$L \{ ( {Y}_{p , k} + ⌊ \frac{m \cdot {N}_{ECCE , p , k}}{L \cdot {M}_{p}^{′ ( L )}} ⌋ + b ) mod ⌊ {N}_{ECCE , p , k} / L \} + i , ⌋$$

k is a sub-frame number, Y_{p,k} is a value of Y on a k^{th} sub-frame on a p^{th} EPDCCH-PRB-set, N_{ECCE,k} is the number of all CCEs on the k^{th} sub-frame on the p^{th} EPDCCH-PRB-set, and i is 0 to (L−1).

The method given above for determining Sₖ^{(L)} or ESₖ^{(L)} based on the search space sharing indicator c is illustrative rather than limiting, and those skilled in the art can conceive of other methods for determining Sₖ^{(L)} or ESₖ^{(L)} based on the search space sharing indicator c.

Furthermore, the corresponding candidate number of the PDCCH/EPDCCH at each aggregation level in the search space corresponding to the serving cell configured to share the search space is configured by the base station.

As an example, if Sₖ^{(L)} is used to indicate a candidate search location of the corresponding PDCCH at the aggregation level L, m′=m+M^{(L)}·c in the formula for calculating the Sₖ^{(L)}, where M^{(L)} is configured by the base station. For example, M^{(L)} is a candidate location number configured by the base station and is less than or equal to the existing candidate location number at each aggregation level, and if the corresponding aggregation level is 1/2/4/8, the M^{(L)} is 2/2/1/1 (the existing candidate location number is 6/6/2/2).

As another example, if ESₖ^{(L)} is used to indicate a candidate search location of the corresponding EPDCCH at the aggregation level L, in the following formula for calculating ESₖ^{(L)}, the M′ₚ^{(L)} is configured by the base station. For example, M′ₚ^{(L)} is a candidate location number configured by the base station and is less than or equal to the existing candidate location number at each aggregation level, and if the corresponding aggregation level is 2/4/8/16/32, the M′ₚ^{(L)} is 2/2/1/1/0.

Correspondingly, in step S202, the user equipment receives and demodulates the PDCCH/EPDCCH based on the specific search space of the user equipment, where in the case of configuring the user equipment with a carrier indicator field (CIF) or an extended carrier indicator field (ECIF) and configuring the user equipment with a shared search space, a candidate location m of a control channel element (CCE) of the PDCCH/enhanced control channel element (ECCE) of the EPDCCH detected by each serving cell configured to share the search space in the whole search space is determined by a cell identification of another configured serving cell sharing the search space therewith.

As an example, if Sₖ^{(L)} is used to indicate a candidate search location of a corresponding PDCCH at an aggregation level L ε{1, 2, 4, 8}, and if the UE for detecting the PDCCH is configured with the carrier indicator field (CIF) or the extended carrier indicator field (ECIF) and the serving cell n_{CI} is configured with the search space sharing indicator c, m′=m+M^{(L)}·c in the following formula for calculating Sₖ^{(L)}, where c is the SCellIndex of the serving cell sharing the search space with said serving cell.

L{(Yₖ+m′)mod └N_{CCE,k}/L┘}+i,

k is a sub-frame number, Yₖ is a constant difference related to k and RNTI allocated by the UE, N_{CCE,k} is the number of all CCEs on a k^{th} sub-frame, and i is 0 to (L−1).

As another example, if ESₖ^{(L)} is used to indicate a candidate search location of a corresponding EPDCCH at an aggregation level L ε{1, 2, 4, 8, 16, 32}, and if the UE for detecting the PDCCH is configured with the carrier indicator field (CIF) or the extended carrier indicator field (ECIF) and the serving cell n_{CI} is configured with the search space sharing indicator c, b is equal to c in the following formula for calculating ESₖ^{(L)}, where c is the SCellIndex of the serving cell sharing the search space with said serving cell.

$$L \{ ( {Y}_{p , k} + ⌊ \frac{m \cdot {N}_{ECCE , p , k}}{L \cdot {M}_{p}^{′ ( L )}} ⌋ + b ) mod ⌊ {N}_{ECCE , p , k} / L \} + i , ⌋$$

k is a sub-frame number, Y_{p,k} is a value of Y on a k^{th} sub-frame on a p^{th} EPDCCH-PRB-set, N_{ECCE,k} is the number of all CCEs on the k^{th} sub-frame on the p^{th} EPDCCH-PRB-set, and i is 0 to (L−1).

Furthermore, the corresponding candidate number of the PDCCH/EPDCCH at each aggregation level in the search space corresponding to the serving cell configured to share the search space is configured by the base station.

As an example, if Sₖ^{(L)} is used to indicate a candidate search location of the corresponding PDCCH at the aggregation level L, m′=m+M^{(L)}·c in the formula for calculating the Sₖ^{(L)}, where M^{(L)} is configured by the base station. For example, M^{(L)} is a candidate location number configured by the base station and is less than or equal to the existing candidate location number on each aggregation level, and if the corresponding aggregation level is 1/2/4/8, the M^{(L)} is 2/2/1/1 (the existing candidate position number is 6/6/2/2).

As another example, if ESₖ^{(L)} is used to indicate a candidate search location of the corresponding EPDCCH at the aggregation level L, in the following formula for calculating ESₖ^{(L)}, the M′ₚ^{(L)} is configured by the base station. For example, M′ₚ^{(L)} is a candidate location number configured by the base station and is less than or equal to the existing candidate location number on each aggregation level, and if the corresponding aggregation level is 2/4/8/16/32, the M′ₚ^{(L)} is 2/2/1/1/0.

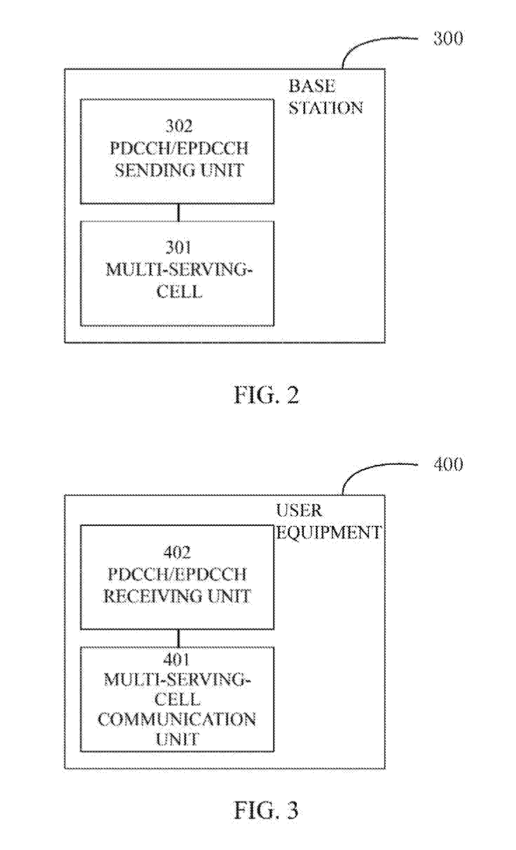

Referring to FIG. 2 and FIG. 3, a structural block diagram of the base station 300 and the user equipment 400 according to embodiments of the present invention is described below.

As illustrated in FIG. 2, the base station 300 includes a multi-serving-cell communication unit 301 and a PDCCH/EPDCCH sending unit 302. The multi-serving-cell communication unit 301 is configured to communicate with the user equipment in multiple serving cells and configure a search space sharing indicator for the multiple cells. The PDCCH/EPDCCH sending unit 302 is configured to send the PDCCH/EPDCCH based on the specific search space of the user equipment to the user equipment, where in the case of configuring the user equipment with a carrier indicator field (CIF) or an extended carrier indicator field (ECIF) and configuring the user equipment with a shared search space, a candidate location of a control channel element (CCE) of the PDCCH/enhanced control channel element (ECCE) of the EPDCCH detected by each serving cell configured to share the search space in the whole search space is determined by a cell identification of another configured serving cell sharing the search space therewith.

As illustrated in FIG. 3, the user equipment 400 includes a multi-serving-cell communication unit 401 and a PDCCH/EPDCCH receiving unit 402. The multi-serving-cell communication unit 401 is configured to communicate with the base station in multiple serving cells, and receive the search space sharing indicator configured by the base station for the multiple cells. The PDCCH/EPDCCH receiving unit 402 is configured to receive the PDCCH/EPDCCH based on the specific search space of the user equipment and sent by the base station and demodulate the PDCCH/EPDCCH according to the shared search space, where in the case of configuring the user equipment with a carrier indicator field (CIF) or an extended carrier indicator field (ECIF) and configuring the user equipment with a shared search space, a candidate location of a control channel element (CCE) of the PDCCH/enhanced control channel element (ECCE) of the EPDCCH detected by each serving cell configured to share the search space in the whole search space is determined by a cell identification of another configured serving cell sharing the search space therewith.

It shall be appreciated that the above embodiments of the present invention can be implemented through software, hardware or a combination of the software and the hardware. For example, various assemblies inside the base station and the user equipment in the above-mentioned embodiments can be implemented through various devices, and these devices include but are not limited to an analog circuit device, a digital circuit device, a digital signal processing (DSP) circuit, a programmable processor, an application-specific integrated circuit (ASIC), a field programmable gate array (FPGA), a complex programmable logic device (CPLD), and the like.

In the present application, the “base station” refers to a mobile communication data and control exchange center with relatively high transmitting power and relatively wide coverage area, and includes a resource allocation and scheduling function, a data receiving-transmitting function, and the like. The “user equipment” refers to a user mobile terminal, for example, a terminal device capable of performing wireless communication with the base station or a micro base station, such as a mobile phone, a notebook computer, and the like.

Furthermore, the embodiments of the present invention disclosed herein may be implemented on a computer program product. More specifically, the computer program product is one of the following products: a computer readable medium, where the computer readable medium is encoded with a computer program logic, and when being executed on a computer device, the computer program logic provides relevant operations so as to implement the above-mentioned technical solution of the present invention. When being executed on at least one processor of a computer system, the computer program logic enables the processor to execute the operations (method) described in embodiments of the present invention. This arrangement of the present invention is typically provided to be arranged or encoded on software, codes and/or other data structures on the computer readable medium such as an optical medium (for example CD-ROM), soft disk or hard disk, other mediums of firmware or micro-codes on one or more ROM, RAM or PROM chips, or downloadable software images, shared databases and the like in one or more modules. The software, firmware or the like can be installed on the computer device, so that one or more processors in the computer device execute the technical solution described in embodiments of the present invention.

Although the present invention has already been described in combination of preferred embodiments of the present invention, those skilled in the art shall appreciate that various modifications, replacements and changes can be made to the present invention without departing from the spirit and scope of the present invention. Therefore, the present invention shall not be limited by the above-mentioned embodiments, but shall be limited by the following claims and equivalences thereof.

1. A communication method in a base station, comprising:
a base station communicating with a user equipment in multiple serving cells, and configuring a search space sharing indicator for the multiple cells; and
the base station sending a physical downlink control channel (PDCCH)/enhanced physical downlink control channel (EPDCCH) based on a specific search space of the user equipment to the user equipment, where in the case of configuring the user equipment with a carrier indicator field (CIF) or an extended carrier indicator field (ECIF) and configuring the user equipment with a shared search space, a candidate location of a control channel element (CCE) of the PDCCH/enhanced control channel element (ECCE) of the EPDCCH detected by each serving cell configured to share the search space in the whole search space is determined by a cell identification of another configured serving cell sharing the search space therewith.

2. The method according to claim 1, wherein the number of corresponding candidate locations of the PDCCH/EPDCCH at each aggregation level in the search space corresponding to the serving cell configured to share the search space is configured by the base station.

3. A communication method in a user equipment, comprising:
a user equipment communicating with a base station in multiple serving cells, and receiving a search space sharing indicator configured by the base station for the multiple cells; and
the user equipment receiving a PDCCH/EPDCCH based on a specific search space of the user equipment, wherein
in the case of configuring the user equipment with a carrier indicator field (CIF) or an extended carrier indicator field (ECIF) and configuring the user equipment with a shared search space, a candidate location of a control channel element (CCE) of the PDCCH/enhanced control channel element (ECCE) of the EPDCCH detected by each serving cell configured to share the search space in the whole search space is determined by a cell identification of another configured serving cell sharing the search space with the serving cell.

4. The method according to claim 3, wherein the number of corresponding candidate locations of the PDCCH/EPDCCH at each aggregation level in the search space corresponding to the serving cell configured to share the search space is configured by the base station.

5. Abase station, comprising:
a multi-serving-cell communication unit, configured to communicate with a user equipment in multiple serving cells, and configure a search space sharing indicator for the multiple cells; and
a PDCCH/EPDCCH sending unit, configured to send a PDCCH/EPDCCH based on a specific search space of the user equipment to the user equipment, wherein
in the case of configuring the user equipment with a carrier indicator field (CIF) or an extended carrier indicator field (ECIF) and configuring the user equipment with a shared search space, a candidate location of a control channel element (CCE) of the PDCCH/enhanced control channel element (ECCE) of the EPDCCH detected by each serving cell configured to share the search space in the whole search space is determined by a cell identification of another configured serving cell sharing the search space with the serving cell.

6. The base station according to claim 5, wherein the number of corresponding candidate locations of the PDCCH/EPDCCH at each aggregation level in the search space corresponding to the serving cell configured to share the search space is configured by the base station.

7. A user equipment, comprising:
a multi-serving-cell communication unit, configured to communicate with a base station in multiple serving cells, and receive a search space sharing indicator configured by the base station for the multiple cells; and
a PDCCH/EPDCCH receiving unit, configured to receive a PDCCH/EPDCCH based on a specific search space of a user equipment, wherein
in the case of configuring the user equipment with a carrier indicator field (CIF) or an extended carrier indicator field (ECIF) and configuring the user equipment with a shared search space, a candidate location of a control channel element (CCE) of the PDCCH/enhanced control channel element (ECCE) of the EPDCCH detected by each serving cell configured to share the search space in the whole search space is determined by a cell identification of another configured serving cell sharing the search space with the serving cell.

8. The user equipment according to claim 7, wherein the number of corresponding candidate locations of the PDCCH/EPDCCH at each aggregation level in the search space corresponding to the serving cell configured to share the search space is configured by the base station.
